(19) United States
(12) Patent Application Publication
(10) Pub. No.: US 2026/0251286 A1
(43) Pub. Date: Aug. 27, 2026

(54) OPTICAL FILTER AND LIGHTING DEVICE SIMULATING THE NATURAL LIGHT OF THE SKY AND THE SUN COMPRISING THE SAME

(71) Applicant: CoeLux S.r.l., Lomazzo (CO) (IT)

(72) Inventor: Paolo Di Trapani, Cavallasca (IT)

(21) Appl. No.: 18/876,941

(22) PCT Filed: Jul. 1, 2022
(86) PCT No.: PCT/IB2022/056146

§ 371 Date: Dec. 19, 2024

(51) Int. Cl. F21V 9/02; F21V 5/00

(52) U.S. Cl. CPC F21V 9/02; F21V 5/007

(57) ABSTRACT

The present invention relates to an optical filter (100) comprising an entry surface (101) substantially flat, an exit surface (102) substantially flat and parallel to the entry surface, a plurality of filled channels (103) made of a solid material, substantially transparent to light, wherein the channels (103) of the plurality of channels comprise an entry face (104), an exit face (105) and a lateral surface extending perimetrically between the entry face (104) and the exit face (105) over a length (L) of the channels (103) measured along an axis of channel (Y), are arranged side by side and parallel to each other, with the axis of channel (Y) parallel to or inclined with respect to the normal to the entry (101) and exit (102) surface and are arranged with the entry face (104) substantially overlapping the entry surface (101) and with the exit face (105) substantially overlapping the exit surface (102), at least one element of optically absorbing material (108) configured and arranged around the channels (103) so as to reduce and/or substantially prevent the passage of light between adjacent channels (103) of the plurality of channels; and a plurality of first and second converging lenses (107), wherein each channel (103) has a converging first lens of the plurality of first and second converging lenses (107) coupled to or defining its entry face (104) and a converging second lens of the plurality of first and second converging lenses (107) coupled to or defining its exit face (105), wherein the first and second lenses (107) of each channel (103) have focal lengths (f) in the channel satisfying the relation 0.5 L<f<2L, preferably 0.7 L<f<1.6L, more preferably 0.7 L<f<1.4L, even more preferably 0.9 L<f<1.2L.

### TECHNICAL FIELD

The present invention relates in general terms to a new optical filter, and in particular to an optical filter configured to transform an incident light into a filtered light having an angular luminance profile characterized by a first substantially constant value for emission directions comprised within an angular acceptance cone and a second substantially zero value for emission directions outside the angular acceptance cone. Such an optical filter is particularly suitable for use in a device that allows the artificial reproduction of a light capable of recreating, indoors, the experience of natural light of the sky and the sun on a clear day. The present invention also relates to a lighting device simulating the natural light of the sky and the sun using such an optical filter as well as a process for producing the optical filter.

### BACKGROUND

It clearly follows from the Applicant's international patent application No. WO 2020/201938 as well as from further experience gained by the Applicant that the main characteristics of natural light on a clear day that distinguish it from the artificial light of the lamps are connected to its ability to:
(i) produce sharp shadows, thanks to the highly directional characteristic of sunlight, which has a divergence of only 0.5 degrees,
(ii) produce blue shadows, as these are illuminated by sky light whose correlated colour temperature—CCT—is much higher than the correlated colour temperature of sunlight,
(iii) produce bright shadows, i.e. with a luminance typically not less than 15-20% of the characteristic luminance of the surfaces exposed both the light of the sky and to the light of the sun,
(iv) produce an image of the sky and the sun perceived by the eye of the observer at an infinite distance, and
(v) produce the image of a clear, cloudless sky and of a round sun in sharp contrast to the sky.

The industrial development of a device capable of producing a natural light identical to natural light according to all five of the above characteristics has never been achieved to date. Furthermore, the intrinsic complexity of achieving such an objective would imply costs that would make it difficult to market any resulting product.

In particular, in order to produce an image of the sun at an infinite distance (characteristic iv) in the eye, it is necessary that the luminance profile of the light is spatially uniform across the observation surface. This is in fact the condition whereby the two eyes, in order to see the same image, must be aligned in a parallel manner, giving the brain the information of an object at substantially infinite distance. Furthermore, in order to ensure the image of a round sun in sharp contrast to a cloudless sky (characteristic v) it is necessary that the angular luminance profile from the sunlight has a substantially constant value up to a maximum angle, and be substantially zero elsewhere. In fact, the eye associates the presence of clouds or haze in the sky with a standard bell-shaped angular luminance profile (e.g. Gaussian), with a sun that gradually “fades” into the sky. As the Applicant has been able to verify directly, this feature is unwelcome to the market, as it compromises the device's ability to evoke the experience of a day with clear sky.

An optical filter theoretically capable of producing a constant luminance within a cone of angular acceptance is the micro-optical tandem mixer, hereinafter referred to more simply as “tandem mixer”, considered by the Applicant in the device described in WO 2020/201938. Such an optical filter consists of two matrices with identical lenses (or micro-lenses), the one facing the other, and arranged at a distance equal to the common focal length. This optical filter produces the uniformly illuminated image of the lens opening in the far field, and therefore also on the retina in the case of infinity vision. This is provided that the lenses of the entry matrix are in turn uniformly illuminated, which is not difficult to achieve in the case of small lenses.

However, the tandem mixer used in WO 2020/201938 has some significant problems in practice. First of all, it reproduces in the far field, in addition to the main image, also one or more secondary or ghost images, with the same shape as the main image, which are also uniformly illuminated, although typically with lower illuminance than the one relative to the main image. This circumstance occurs when the light entering the channels constituted by the pairs of facing lenses also comes from directions outside the acceptance cone of the filter, delimited by the bundle of straight lines passing through the centre of the entry lens and the edge of the exit lens. Typically this happens, for example, when the light to be mixed comprises, in addition to a main component having characteristics of high and controlled directionality, also a secondary or spurious component, also called “stray light”, for example associated with the presence of imperfections in the optical system that produce uncontrolled phenomena of diffusion and/or multiple reflection of the light, as often happens in the case of the use of Fresnel optics. Or, it occurs when the entering light comprises tails in the angular profile, as is frequently the case with a regular angular profile of the Gaussian type. In such circumstances, the undesired phenomenon that occurs is due to the interaction or “cross talk” between adjacent channels, as they are not optically independent of each other. Specifically, the light entering through an entry lens of one channel, coming from directions outside the acceptance cone, exits through the exit lens of a different channel, producing a ghost image laterally to the main image, associated with a second luminance profile that is identical to the first except for the fact that it manifests itself at a different exit angle.

A second problem of the tandem mixer used in the device described in WO 2020/201938 is given by the fact that, in order to ensure maximum simplicity of construction and maximum brightness, the lens matrices composing it are made up of square, rectangular or hexagonal lenses, or in any case with a shape that allows maximum compaction and therefore maximum coverage of the entry and exit surfaces. Consequently, the image they produce in the far field is not circular but square, or rectangular, or hexagonal etc.

In summary, a device that simply used a tandem mixer as described in WO 2020/201938 would produce in the sky the main image of a square (or rectangular, or hexagonal) sun surrounded by ghost images that are identical to the main one except for the fact of being less intense.

In order to eliminate the problem of secondary images, in WO 2020/201938 it was considered to introduce, downstream of the tandem mixer, a spatial filter obtained by means of a matrix of parallel absorbing channels, hereinafter more simply referred to as “absorbing channel spatial filter”, such channels being for example organized according to a honeycomb structure. This absorbing channel spatial filter, however, has the defect of introducing a regular pattern in the luminance profile that is easily perceivable by the observer, and for the removal thereof the Applicant has proposed the introduction of a further filter, i.e. a low-angle diffuser filter, downstream of it. Significantly, such a low-angle diffuser also has the purpose of mitigating the second mentioned problem of the tandem mixer, in that it allows the image of an object positioned beyond it to be blurred, the further away the object is, thus turning the images of squares, rectangles, hexagons etc. into circles.

In this way, a sun in stark contrast to the sky was dispensed with. In fact, both the spatial filter with absorbing channels, due to the geometric cut it imposes on the light propagating at higher angles, and the low-angle diffuser filter, independently and therefore co-operatively, transform an angular profile of constant luminance, like the one produced by the tandem mixer, into a bell-shaped profile. In practice, the result produced by the device described in WO 2020/201938 is to produce an image of a strongly blurred sun, with contours that gradually fade into the sky, as happens in nature in the presence of haze or thin clouds in the upper atmosphere.

### SUMMARY OF THE INVENTION

It is therefore an object of the present invention to devise an optical filter capable of generating a light having an angular distribution having a characteristic shape assimilable to the characteristic shape of the angular distribution of the light of the sun, i.e., an angular distribution characterized by a substantially constant value of the luminance for directions within a certain solid angle, i.e., the solid angle or cone subtended by the image of the sun, and substantially zero elsewhere, said value being equal to 0.25 degrees in case one intends to favour the reproduction of an angular opening equal to that of the natural sun, possibly at the expense of the obtainable luminous flux, or a greater value, for example 10 or 100 times greater, in case one intends to maximise the luminous flux produced by the artificial sun.

All this must take place independently of the angular distribution of the entering light, i.e. both in the presence of stray light—be it characterized by the presence of a background for all directions, or by an angular luminance profile with peaks, even intense ones, for directions outside or very outside the cone subtended by the image of the sun—and in the presence of important tails in the angular profile at angles close to the opening angle of the angular acceptance cone, thus eliminating the undesired effect caused by optical components of standard use in the lighting sector.

A further object of the present invention is to devise an optical filter which, when used in a lighting device simulating the natural light of the sky and the sun, is capable of generating an infinity image of a sun with well-defined contours.

Another object is to devise an optical filter which, when used in a lighting device simulating the natural light of the sky and the sun, makes it superfluous to use both spatial filters with absorbing channels and low-angle diffuser filters, allowing the sharp contrast between the image of the sun and of the sky to be preserved.

It is not the least object of the present invention to realize a lighting device simulating the natural light of the sky and the sun capable of providing an infinity image of a circular sun with well-defined contours.

These and other purposes of the present invention are achieved by means of an optical filter for lighting devices simulating the natural light of the sky and the sun, incorporating the features of the appended claims, which form an integral part of the present description.

In accordance with a first aspect thereof, the invention thus relates to an optical filter configured to transform an incident light into a filtered light having an angular luminance profile characterized by a first substantially constant value for emission directions comprised within an angular acceptance cone and a second substantially zero value for emission directions outside the angular acceptance cone, wherein the optical filter comprises a substantially flat entry surface, a substantially flat exit surface parallel to the entry surface, a plurality of solid channels, made of at least one solid material, substantially transparent to light.

The channels of the plurality of channels comprise an entry face, an exit face and a lateral surface that extends perimetrically between the entry face and the exit face over a length L of the channels measured along an axis of the channel. The channels are also arranged side by side and parallel to each other, with the axis of channel Y parallel or inclined with respect to the normal to the entry and exit surfaces, and are arranged with the entry face substantially overlapping the entry surface and with the exit face substantially overlapping the exit surface.

There is also provided at least one optically absorbing material element configured and arranged around the channels in such a way as to reduce and/or substantially prevent the passage of light between adjacent channels of the plurality of channels.

Again, there is provided a plurality of first converging lens and a plurality of second converging lens, with each channel having a first lens of the plurality of first lenses coupled or defining the entry face thereof and a second lens of the plurality of second lenses coupled or defining the exit face thereof. In addition, the first and second lenses have focal lengths in the channel that satisfy the relation 0.5 L<f<2L, preferably 0.7 L<f<1.6L, more preferably 0.7 L<f<1.4L, even more preferably 0.9 L<f<1.2L, or of further preference, substantially equal to the channel length L.

In the context of this description and the appended claims, the focal length in the channel means the distance of the focal plane of the lens from the centre of gravity of the entry or exit face of the channel to which the lens is coupled; this distance is measured within the channel or generally within the at least one solid material by which the channel is constituted, with the lens illuminated by green light having a wavelength of around 532 nm. In the context of the present description and the appended claims, in the case of astigmatic lenses or lenses characterized by other aberrations, the focal plane means the plane orthogonal to the axis of the channel where the image of an object at infinity, i.e., the image produced by a collimated light incident on the lens along the direction of the axis of the channel, assumes the minimum area.

In the context of the present description and in the appended claims, a (entry or exit) face of a channel is said to be substantially overlapping, or hereinafter simply overlapping, on an (entry or exit) surface of the optical filter when at least one point of the face of the channel belongs to the surface, for example when the whole face belongs to the surface, in the case of a flat face, or when the perimeter of the face belongs to the surface, in the case of a curved face.

The optical filter object of the present invention behaves substantially like as a ghost-image-free tandem filter, producing a single clear image of the sun thanks to the optically absorbing material element configured and arranged around each channel in such a way as to remove cross-talk between the channels at the origin. More specifically, the optical filter object of the present invention makes it possible to produce a substantially constant luminance profile within the angular acceptance cone of the filter by producing in the far field an image equal to the average of the projections of the entry faces of the channels in a plane orthogonal to the axis of channel Y. In this respect, the optical filter object of the present invention differs substantially from the combination consisting of a conventional tandem filter followed by a spatial filter obtained by means of a matrix of parallel absorbing channels, in that the latter produces an angular profile of luminance that attenuates substantially linearly from the direction of the axis of channel to the direction corresponding to the cut-off angle, thereby producing a blurred image of the sun, i.e., without a contour characterized by a substantial discontinuity or variation in luminance value, i.e., not in sharp contrast to the sky.

The introduction of the optically absorbing material element inside the optical filter, instead of outside as in the case of the tandem filter followed by the spatial filter with absorbing channels, thus makes it possible to achieve not only the removal of ghost images, but also to advantageously avoid a blurring of the image of the sun.

Advantageously, the introduction of the optically absorbing material element inside the optical filter, instead of outside as in the case of the tandem filter followed by the absorbing channel spatial filter, allows the light transmission value of the optical filter to be significantly increased compared to the typical value produced by the absorbing channel spatial filter. In fact, for an incoming light with a constant luminance angle profile for polar angles smaller than the acceptance or cut-off angle of the absorbing channel filter, and zero elsewhere, the light transmission value of the absorbing channel filter is of the order of 50 percent net of any Fresnel losses due to interface reflections.

On the other hand, in the case of a constant luminance angle profile for polar angles smaller than the acceptance or cut-off angle of the optical filter object of the present invention, and zero elsewhere, the optical filter object of the present invention provides a light transmission value significantly greater than 50%, for example a light transmission value greater than 60%, preferably higher than 70%, still more preferably higher than 80%, or even more preferably higher than 90%, net of any Fresnel losses due to interface reflections.

Moreover, the optical filter according to the present invention is of simple and economical technological feasibility. In fact, the choice of using transparent channels made of solid material and coated with absorbing material makes production industrially scalable. In fact, it is extremely simple to produce transparent channels coated or covered with absorbing material, using, for example, well-established technologies such as that of optical fibres, and in particular such as the one related to the production of optical filters known as “optical face plates”, made, for example, by forming blocks of optical fibres, e.g. optical fibres of glass or polymeric material, such blocks being obtained by heating and compressing a bundle of fibres, such fibres being easily covered by means of an optically absorbing material suitably integrated into the pre-forms of the fibres or interposed in the spaces between them (EMA—Extra Mural Absorber), such blocks being then subsequently cut into slices of the thickness desired for the realization of the filter. With regard to the manufacture of the plurality of lenses, depending on the materials used, the size of the channels, and the desired accuracies, the technologies that can be used comprise ink-jet printing, thermal melting of the fibre head, machining, and chemical etching.

Advantageously, the use of fibre-optic technology makes it easy to obtain channels with a circular or medium-circular cross-section, thus guaranteeing the production in the far-field of an image of the sun that is not only characterized by a sharp contour and a substantially constant luminance profile, but also by a substantially circular shape, thus making the use of low-angle diffuser filters, whose use in order to make the angular luminance profile circular inevitably produces a blurred image of the sun, no longer necessary.

In accordance with a second aspect thereof, the invention relates to an optical filter configured to transform an incident light into a filtered light having an angular luminance profile characterized by a first substantially constant value for emission directions comprised within an angular acceptance cone and a second substantially zero value for emission directions outside the angular acceptance cone, wherein the optical filter comprises a substantially flat entry surface, a substantially flat exit surface parallel to the entry surface, a plurality of solid channels, made of at least one solid material, substantially transparent to light.

The channels of the plurality of channels comprise an entry face, an exit face and a lateral surface that extends perimetrically between the entry face and the exit face over a length L of the channels measured along an axis of channel Y. The channels are also arranged side by side and parallel to each other, with the axis of channel Y parallel or inclined with respect to the normal to the entry and exit surfaces, and are arranged with the entry face substantially overlapping the entry surface and with the exit face substantially overlapping the exit surface.

There is also provided at least one optically absorbing material element configured and arranged around the channels in such a way as to reduce and/or substantially prevent the passage of light between adjacent channels of the plurality of channels.

Again, there is provided a plurality of first converging lens and a plurality of second converging lens, with each channel having a first lens of the plurality of first lenses coupled or defining the entry face thereof and a second lens of the plurality of second lenses coupled or defining the exit face thereof.

Further, the assembly constituted by the plurality of channels, the at least one optically absorbing material element and the plurality of first and second converging lenses is configured such that, given an object plane located at a distance D from the entry surface, it generates an image plane located at the same distance D from the exit surface, the distance D being measured along the direction of the axis of channel and being comprised between 0.5 D₁ and 2 D₁, preferably being comprised between 0.7 D₁ and 1.5 D₁, more preferably being between 0.8 D₁ and 1.3 D₁, even more preferably being comprised between 0.9 D₁ and 1.15 D₁ with D₁ being a nominal distance given by the relation:

$${D}_{1} ≃ \frac{L}{n}$$

where n is the refractive index of the at least one solid material with which the channels are made.

Advantageously, the optical filter according to the second aspect of the present invention achieves the technical effects described above in relation to the optical filter according to the first aspect of the present invention.

The aim set forth above, as well as the objects of the present invention, are likewise achieved by a lighting device for reproducing the light of the sky and the sun according to the attached claim 28.

Further features of the preferred embodiments of the optical filter and lighting device according to the present invention are the subject of the dependent claims.

### BRIEF DESCRIPTION OF THE DRAWINGS

The accompanying drawings, which are incorporated herein and form part of the description, illustrate exemplary embodiments of the present invention and, together with the description, are intended to illustrate the principles of the present invention.

In the drawings:

FIGS. 1a and 1b are respectively a schematic perspective view from above and below of a first embodiment of an optical filter according to the present invention;

FIGS. 2a and 2b are two channel details used to realize the optical filter of FIGS. 1a and 1b.

FIG. 3 is a sectional view of the optical filter of FIGS. 1a and 1b;

FIGS. 4a and 4b are schematic plan views, respectively, of a channel used to realize an optical filter according to a further embodiment of the present invention and of a surface portion of the optical filter according to said further embodiment of the present invention;

FIG. 5a is a schematic plan view of a surface of an optical filter according to another embodiment of the present invention;

FIG. 5b shows an image obtained by illuminating the filter of FIG. 5a with a diffused light source;

FIG. 6a shows a schematic plan view of a surface of an optical filter according to a different embodiment of the present invention;

FIG. 6b shows an image obtained by illuminating the filter of FIG. 6a with a diffused light source;

FIG. 7 is a sectional view of an optical filter according to a further embodiment of the present invention;

FIG. 8 is a sectional view of an optical filter according to a different embodiment of the present invention; and

FIG. 9 is a schematic perspective view of a lighting device to reproduce the light of the sky and the sun according to the present invention.

### DETAILED DESCRIPTION

The following is a detailed description of exemplary embodiments of the present invention. The exemplary embodiments described herein and illustrated in the drawings are intended to convey the principles of the present invention, allowing the person skilled in the art to implement and use the present invention in numerous different situations and applications. Therefore, the exemplary embodiments are not intended, nor should they be considered, to limit the scope of patent protection. Rather, the scope of patent protection is defined by the attached claims.

For the illustration of the drawings, use is made in the following description of identical numerals or symbols to indicate construction elements with the same function. Moreover, for clarity of illustration, certain references may not be repeated in all drawings.

The use of “for example”, “etc.”, “or” indicates non-exclusive alternatives without limitation unless otherwise indicated. The use of “comprises” and “includes” means “comprises or includes, but not limited to”, unless otherwise indicated.

Furthermore, the use of measures, values, shapes and geometric references (such as perpendicular and parallel) associated with terms such as “approximately”, “almost”, “substantially” or similar, is to be understood as “without measurement errors” or “unless inaccuracies due to manufacturing tolerances” and in any case “less than a slight divergence from the values, measures, shapes or geometric references” with which the term is associated.

Finally, terms such as “first”, “second”, “upper”, “lower”, “main” and “secondary” are generally used to distinguish components belonging to the same type, not necessarily implying an order or a priority of relationship or position.

With reference to the accompanying figures, some embodiments of an optical filter according to the present invention are schematically illustrated, indicated as a whole with 100. The optical filter 100 comprises a substantially flat entry surface 101, a substantially flat exit surface 102 parallel to the entry surface, and a plurality of channels 103 extending between the entry surface 101 and the exit surface 102 over a length L. By “substantially flat” it is meant at least locally flat, i.e., flat over an area having a diameter of at least 10 times, preferably 30 times, more preferably 100 times the length of the channels L. The channels 103 are solid channels made of at least one solid material and substantially transparent to light. “Solid material substantially transparent to light” refers to a solid and substantially transparent material, such as glass, quartz, PMMA, polycarbonate, polystyrene, silicone, polyvinylidene fluoride, fluorinated polymers, low refractive index polymers, high refractive index polymers, nanoparticle filled polymers, or other polymer resin.

The channels 103 of the plurality of channels comprise an entry face 104, an exit face 105 and a lateral surface extending perimetrically between the entry face 104 and the exit face 105 over a length L of the channels 103. The channels are arranged side by side and parallel to each other. Further, the channels 103 have an axis of channel Y passing through a centre of gravity of a channel section 103 and incident on the entry surface 101 and exit surface 102, said axis being parallel or inclined with respect to the normal to the entry or exit surface, said channels being arranged with the entry face 104 substantially overlapping the entry surface 101 and with the exit face 105 substantially overlapping the exit surface 102. There is also provided an optically absorbing material element 108 configured and arranged with respect to the channels 103 so as to reduce or substantially eliminate the passage of light between adjacent channels 103 of the plurality of channels.

In a preferred embodiment, the channels 103 are configured such that light rays crossing any one channel 103 of the plurality of channels 103 and belonging to a beam of rays emerging from a point of an entry face 104 of the channel exit the exit face 105 of the channel with substantially parallel directions. In the context of the present description and the appended claims, a beam of light exiting a channel is intended to propagate along substantially parallel directions if its HWHM divergence is significantly less than the angle of the cone of angular acceptance of the filter, e.g. an angle of divergence at least 2 times, preferably at least 3 times, more preferably at least 5 times less than the angle of the cone of angular acceptance of the filter.

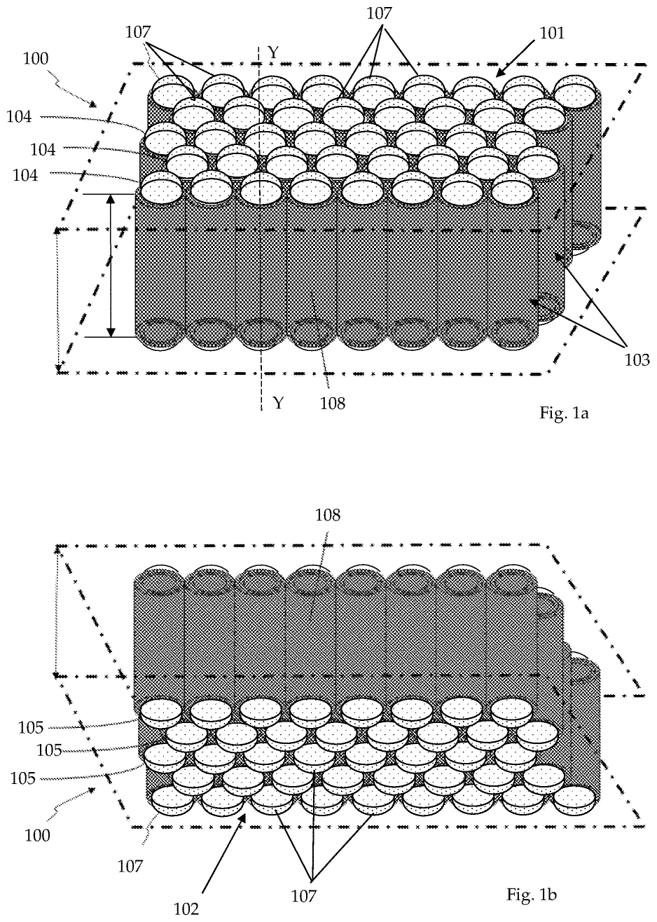

In the exemplary and non-limiting embodiment of FIGS. 1a and 1b, the channels 103 are cylindrical channels with substantially circular section, identical to each other made of a material, preferably selected from the group comprising glass, quartz, PMMA, polycarbonate, polystyrene or other polymer resin. Each cylindrical element 103 has a flat entry face 104, perpendicular to the axis Y of the channel, and a flat exit face 105 parallel to the entry face 104. Both the entry 104 and exit 105 faces are substantially circular and have a diameter equal to a cylindrical element diameter. Advantageously, an optical filter 100 where each channel has a cylindrical conformation having a substantially circular section allows, e.g., in the case of a diffused lighting source, to produce an angular profile of luminous intensity independent of the azimuth angle, so that an optical filter comprising a plurality of such channels produces an angular luminance profile independent of the azimuth angle, as necessary in order to be able to reproduce the image of a round sun.

On both the entry 104 and exit 105 faces of each channel 103 a convex flat converging lens 107 is positioned, glued, deposited or facing through a substrate and having focal length f in the channel satisfying the relation 0.5 L<f<2L, preferably 0.7 L<f<1.6L, more preferably 0.7 L<f<1.4L, still more preferably 0.9 L<f<1.2L, where L is the length of the channel. In a preferred embodiment, however, the convex flat converging lens 107 has focal length f in the channel substantially equal to the length of the channel L, and plan substantially coincident with the respective entry face 104 or exit face 105. By “focal length f in the channel substantially equal to the length of the channel L” it is meant that the difference between focal length f and channel length L is not on average greater than 50%, preferably 30% more preferably 20%, even more preferably 10% of the length of the channel L.

Alternatively, as shown in FIG. 3, both the entry 104 and exit 105 faces of each channel 103 integrate a converging lens 107 having a base substantially coincident with the respective face 104,105 of the channel 103, thereby forming a single piece assembly with the channel 103. In this case, the entry 104 and exit 105 faces of a channel are defined as the section of the channel in the plane of the entry and exit surfaces, respectively, as illustrated in FIG. 3.

The channels 103 are arranged side by side and parallel to each other. Preferably, the channels 103 are arranged in a maximum packing condition, for example according to a hexagonal pattern, and having the entry face 104 positioned on the same flat entry surface 101 as the filter 100 and the exit face 105 positioned on the same flat exit surface 102 as the filter and parallel to the entry surface 101.

In the illustrated embodiments, the optical filter 100 has the axis of channel Y perpendicular to the entry surface 101 and to the exit surface 102 of the optical filter 100. However, in a completely general way, the axis of channel Y of the optical filter 100 according to the present invention may have any inclination with respect to the normal to the entry 101 or exit 102 surface, for example an inclination comprised between 10° and 80°.

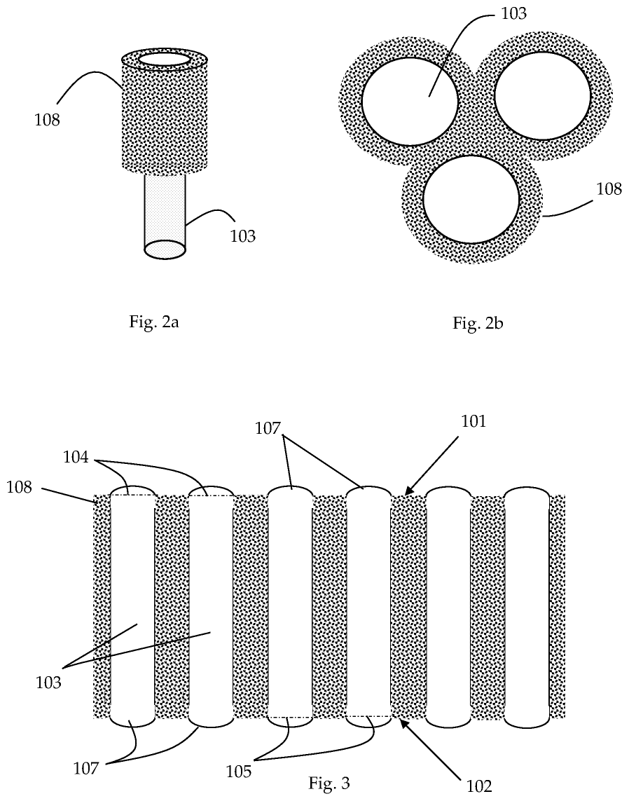

As illustrated in FIG. 2a, the channels 103 have a lateral surface substantially covered under conditions of optical contact (without gaps) by an optically absorbing material element 108, for example in the form of a sheath, film or varnish, having a refractive index substantially equal to or close to the refractive index of the solid material by which the channels 103 are constituted, in order to minimise any reflection at the interface. In particular, the first optically absorbing material element 108 is arranged and configured to absorb the light that would otherwise propagate from inside to outside the channel and thus prevent the passage of light between adjacent channels. In different embodiments, the absorbing material may have a refractive index less than or greater than the refractive index of the channel material adjacent to it, e.g., a refractive index that differs between 1% and 10%. For example, a different refractive index can be connected to the presence of specific thermal and/or mechanical properties of the absorbing material that facilitate obtaining the covering of the channel by the absorbing material.

FIGS. 2b and 3 show that the interspaces between adjacent channels 103 are substantially completely filled by the optically absorbing material member 108, so as to prevent not only the passage of light between adjacent channels, but also the passage of light parallel to the channels and externally thereto through the interspaces that might otherwise form between adjacent channels 103.

Note that if the axis of the channel Y is inclined with respect to the normal to the entry or exit surface by an angle α (not illustrated) other than 0, the shape from the section of each channel may be obtained, for example, by projecting the entry face 104 or the exit face 105 of the channel onto the plane orthogonal to the axis of the channel Y, i.e., on the section plane.

According to an alternative embodiment, the material by which the optically absorbing material element is formed is preferably obtained from a modification of the material by which the channels 103 are constituted by addition of light absorbing components. Alternatively, the optically absorbing material element 108 is made of a material other than the material(s) by which the channels 103 are constituted, for example having a glass transition temperature that is lower than or higher than the glass transition temperature of the material(s) comprising the channels 103, for example having a glass transition temperature that differs in the range comprised between 1% and 10% from the glass transition temperature of the material(s) constituting the channels.

In a particular embodiment, the assembly constituted by the plurality of channels 103, the at least one optically absorbing material element 108 and the plurality of first and second converging lenses 107 is configured such that, given an “object plane” in front of and parallel to the entry surface 101 and placed at a distance D from said entry surface 101 it is possible to associate with the optical filter 100 an “image plane” behind and parallel to an exit surface 102, placed at the same distance D from said exit surface 102 such that a light source of linear shape and lying on the object plane along a source direction substantially orthogonal to the axis of channel Y produces in the image plane an image of the source that is, it produces an illuminance profile characterized by a contrast along a direction orthogonal to the source direction and/or a peak illuminance value respectively greater than the contrast and/or the peak illuminance value obtained in any other plane behind the exit surface 102 and in front of the image plane, and wherein the distance D is preferably comprised between 0.5₁ and 2 D₁, more preferably comprised between 0.7 D₁ and 1.5 D₁, more preferably comprised between 0.8₁ and 1.3 D₁, even more preferably comprised between 0.9 D₁ and 1.15 D₁ with D₁ being a nominal distance given by the following relation:

$${D}_{1} ≃ \frac{L}{n}$$

wherein:

the nominal distance D1 is measured along the direction of the axis of channel Y, L is the length of the channels 103 and n is the refractive index of the at least one solid material by which the channel is constituted and where the terms “in front” and “behind” are to be understood with respect to a direction of propagation of the light generated by the linearly shaped light source and crossing the optical filter 100.

Although the embodiment illustrated in FIGS. 1a and 1b explicitly refer to channels of cylindrical shape with circular section, this embodiment is equally applicable to channels of any shape.

According to other embodiments, the optical filter according to the present invention has a plurality of channels characterized by a distribution of channels having substantially non-circular sections. In the context of the present description and in the appended claims, the expression “distribution of substantially non-circular channels” is intended to mean a plurality of channels such that an average over the plurality of channels of the ratio among the radii of the circumferences circumscribed and inscribed to the section of each channel has a value greater than 1.05, preferably greater than 1.2, more preferably greater than 1.3. Preferably, the average of the ratio among the radii of the circumferences circumscribed and inscribed to the section of each channel has a value lower than 3, preferably lower than 2.5, more preferably lower than 2. An example of distribution of channels having substantially non-circular sections is a distribution of channels having a substantially elliptical section.

In the context of the present description and in the appended claims, the expression “inscribed circumferences” is intended to mean a plurality of inscribed circumferences, wherein each circumference is inscribed in the section of a respective channel. In the context of the present description and in the appended claims, the expression “circumscribed circumferences” is intended to mean a plurality of circumscribed circumferences, wherein each circumference circumscribes the section of a respective channel.

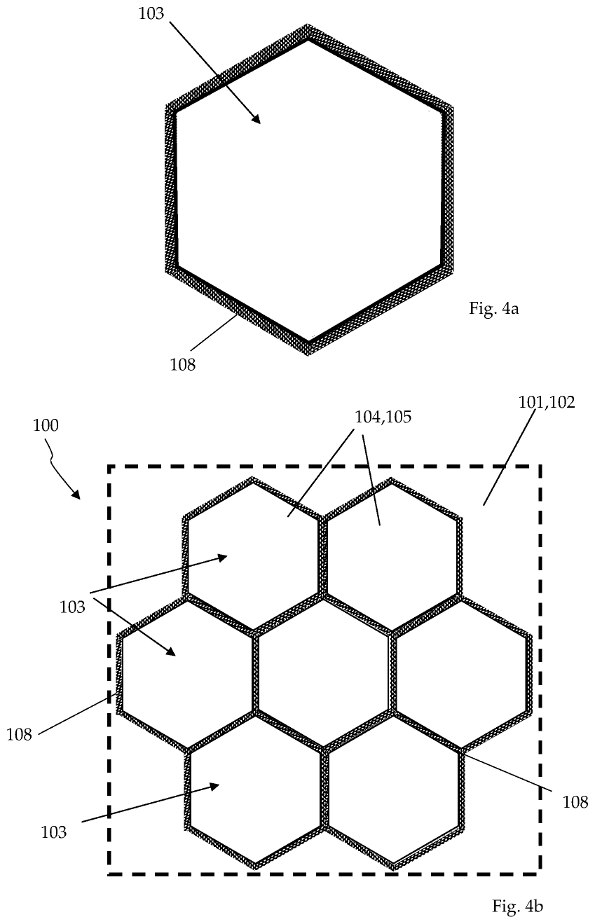

According to different embodiments, the optical filter comprises a plurality of channels with a polygonal section. Advantageously, channels with a polygonal section allow a greater covering or tessellation of the plane than in the case of channels with a circular section, and therefore a greater overall section of channels capable of collecting the incident light and a possible greater transmission efficiency. In fact, this conformation allows to optimise the occupation of the surfaces of the filter by the sections of the channels, reducing any possible interspaces to a minimum. Preferably, the optical filter may comprise a plurality of channels having a regular polygonal section, for example with a triangular, square or hexagonal section. An example of a channel with a hexagonal section 103 and relative optical filter 100 are shown respectively in FIGS. 4a and 4b.

According to other embodiments of the invention, the optical filter has a plurality of channels characterized by a distribution of channels having sections which are substantially not equal between them. In particular, in the context of the present description and in the appended claims, the expression “distribution of channels having sections that are not substantially equal” is intended to mean a plurality of channels such that each channel has a section having an effective radius of channel Rc substantially different from the effective radius of channel Rc of at least another channel and/or has a shape substantially different from the shape of the section of at least another channel, where the effective radius of channel is defined as

$${R}_{c} ≡ \frac{\sqrt{{A}_{c}}}{n}$$

and where Ac is the area of the section of the channel.

By way of non-limiting example, a first embodiment characterized by a distribution of channels having sections that are not substantially equal has a standard deviation of the distribution of the effective radii Rc having a value comprised between 2% and 50%, preferably between 3% and 30%, more preferably between 4% and 20% of the value of the average radius R, where “average radius” is intended to mean the average of the channel effective radii R≡<R_{c}>.

By way of further non-limiting example, in a different embodiment characterized by a distribution of channels having sections that are not substantially equal the optical filter comprises a plurality of channels such that the distribution of the radii of the circumferences inscribed in each section of each channel has a standard deviation greater than 2%, preferably 4%, more preferably 6% of the average value over the same distribution, the sections being in the plane orthogonal to the longitudinal axis. Preferably, the standard deviation is lower than 70%, preferably 50%, more preferably 30% of the average value.

According to other embodiments of the invention, the optical filter has a plurality of channels characterized by a distribution of averagely circular channels. In particular, in the context of the present description and in the appended claims, the expression “distribution of averagely circular channels” means a distribution of channels having substantially randomly oriented sections in a section plane. More particularly, the expression “distribution of averagely circular channels” is understood to mean a distribution such that: the locus of the points {x,y} in the section plane satisfying the relation F(x, y)>CFₘₐₓ is essentially a circle, i.e., it is a surface delimited by a perimeter where a maximum distance of the perimeter from a centre and a minimum distance of the perimeter from the centre differ from each other in an amount lower than 30%, preferably 20%, more preferably 10% of an average distance of the perimeter from the centre, where the average is carried out over the perimeter of the channel and where C=0.5, preferably C=0.3, more preferably C=0.2, and where is a function obtained:
by translating without rotating in the section plane (x,y) all the sections of the channels so that they are aligned vertically, i.e. along the coordinate y, and horizontally, i.e. along the coordinate x, to a centre, and
by attributing to F(x,y) a value equal to the number of translated sections comprising the point (x,y).

By way of non-limiting example, in an embodiment characterized by a distribution of channels having averagely circular sections, the angular profile of luminous intensity I(θ, φ) of the optical filter 100 when illuminated by a diffused light (i.e., by a light with a substantially uniform luminance profile, i.e. independent of the position, and isotropic, i.e. substantially Lambertian), is substantially independent or weakly dependent on φ, where θ is the polar angle with respect to the direction of the channels and φ is the azimuth angle. For example, the angular profile of luminous intensity I(θ,φ) of the light produced by any portion of the optical filter 100 when illuminated by a diffused light is substantially independent or weakly dependent on the azimuth angle φ, where said portion circumscribes a circle having a radius equal to 15 cm, preferably at least equal to 10 cm more preferably at least equal to 5 cm.

Particularly, the angular profile of luminous intensity I(θ,φ) of the optical filter 100 illuminated by a diffused light is such that the region in the space of the angular coordinates (θ, φ) outside of which I(θ, φ) assumes a value lower than 50%, preferably 70%, more preferably 80% of the peak value is substantially a cone with a circular or elliptical base characterized by a minor axis of the ellipse having a length equal to at least 50%, preferably 60%, more preferably at least 70% of the major axis of the ellipse, or it is a cone wherein the difference between the maximum and minimum polar angles is lower than 30%, preferably 20%, more preferably 10% of the average polar angle, the average being carried out on the azimuth angles.

According to other embodiments of the invention, the optical filter has a plurality of channels characterized by a distribution of channels that are statistically equivalent to each other. In particular, in the context of the present description and in the appended claims, the expression “plurality of statistically equivalent channels” means that the probability that a channel has a certain characteristic, for example a section of a certain area, shape, or orientation in the section plane, is substantially the same for each channel of the plurality of channels, or that this distribution produces local average values, such as the average of the areas and/or of the shapes and/or of the orientation of the sections, which are substantially independent of the particular position in the section plane, the local average being understood to mean, for example, the average over a circular area with a radius equal to 15 cm, preferably equal to 10 cm, more preferably equal to 5 cm. By way of non-limiting example, an embodiment characterized by a distribution of channels that are statistically equivalent to each other has:
a distribution of radii of the inscribed circumferences with standard deviation greater than 3%, preferably 5%, more preferably 7% of the average value on the optical filter 100, and
a distribution of a local average of the radii of the plurality of inscribed circumferences with standard deviation of less than 5%, preferably 3%, more preferably 1% of the average value over the entire optical filter, said local average being carried out over an area of the optical filter comprised in a circle of radius less than 15 cm, preferably less than 10 cm, more preferably less than 5 cm.

Preferred embodiments of the optical filter according to the present invention may comprise a plurality of channels characterized by a distribution of channels presenting a combination of the characteristics discussed above, and in particular a distribution of channels
(i) that are substantially non-circular, and/or
(ii) having sections that are not substantially equal, and/or
(iii) medium circular, and/or
(iv) statistically equivalent to each other.

Advantageously, a configuration of the filter which provides for a plurality of channels with substantially non-circular sections allows a better covering or tessellation than in the case of circular channels.

Advantageously, a configuration of the filter which provides for a plurality of channels having sections that are not substantially equal reduces the demand for high precision in the production phase, and thus production times and costs, and also favours a random arrangement and orientation of the sections of the channels, so as to allow the optical filter to produce an angular luminance profile that is substantially isotropic, i.e., independent of the azimuth coordinate, as required to produce an image of a circular sun.

Advantageously, a configuration of the filter which provides for a plurality of averagely circular channels further facilitates obtaining an optical filter capable of producing an angular luminance profile that is substantially independent of the azimuthal coordinate.

Advantageously, a configuration of the filter that provides for a plurality of channels statistically equivalent to each other results in an invariance of the optical properties of the filter as perceived by an observer with respect to the specific position observed inside the filter, regardless of how much the properties of a single channel differ from those of another channel. Considering for example channels with an average radius R<0.5 mm, R<0.2 mm, more preferably R<0.1 mm, characterized by a cut-off angle θ₀>1°, preferably θ₀>2°, more preferably θ₀>4°, the number of channels participating in forming the image of the sun in the observer at a typical distance from the filter, i.e. at a distance greater than a few tens of centimetres, is greater than several hundreds, thousands or tens of thousands of units, i.e. sufficient to produce a perception of the average luminance in the observer any point of the optical filter 100. In the context of the present description and in the appended claims with “cut-off angle” of the filter θ₀ it is intended to indicate the average of the polar angle, measured with respect to the longitudinal axis, such that the angular luminance profile of the filter substantially cancels out (due to the presence of the first optically absorbing material interposed between adjacent channels), i.e. it assumes a value equal to 1/10, preferably 1/20, preferably equal to 1/30 of the peak value, e.g. in the case in which the filter is illuminated by a diffused light, i.e. by a light with a uniform and isotropic luminance profile, the average being evaluated with respect to the azimuth angle and over the whole surface of the filter. Alternatively, the cut-off angle of the filter θ₀ is the average over the azimuth coordinate of the polar angle value so that the luminous intensity profile of the filter substantially cancels out when the filter is illuminated by a diffused light. In the context of the present description and in the following claims, the angle of θ₀ coincides with the angle of the angular acceptance cone of the filter. In the context of the present description and in the appended claims, the cut-off angle of the filter θ₀ is equivalently referred to as the acceptance angle θ₀ or half-opening angle of the acceptance cone θ₀.

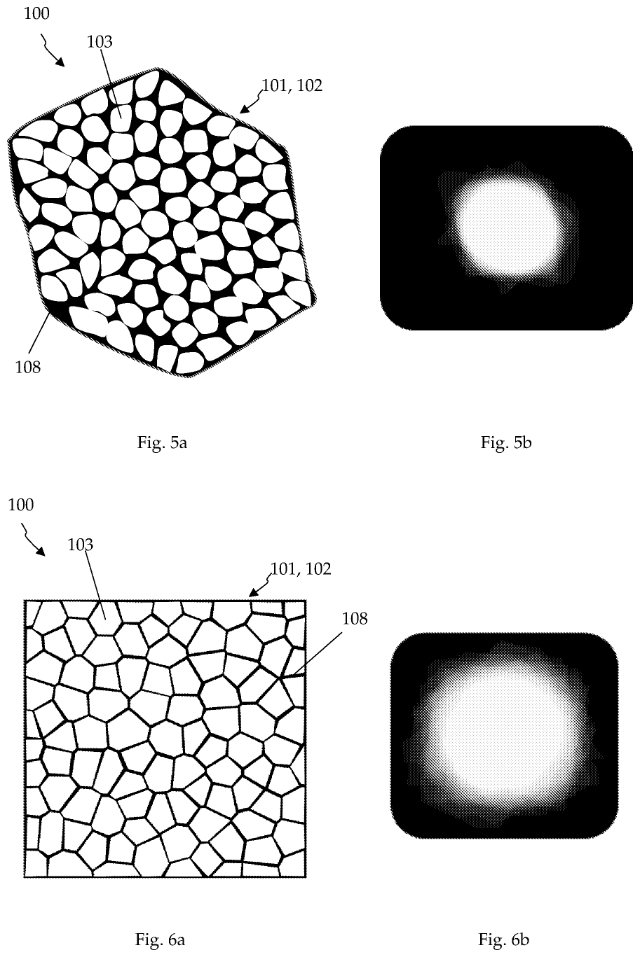

According to different embodiments, the optical filter comprises a plurality of channels with a non-polygonal section, for example with a non-polygonal concave section or a non-polygonal convex section. An optical filter 100 comprising a plurality of channels with a non-polygonal section is illustrated by way of non-exhaustive example in FIGS. 5a-5b. In the example shown in FIG. 5a, the filter has a plurality of channels 103 characterized by a distribution of substantially non-circular channels, having sections that are substantially not equal, averagely circular, and statistically equivalent between them.

According to further embodiments, the optical filter comprises a plurality of channels with a non-regular polygonal section, for example with a convex non-regular polygonal section. An optical 100 comprising a plurality of channels with a non-regular convex polygonal section is illustrated by way of non-exhaustive example in FIGS. 6a-6b. In the example shown in FIG. 6a, the filter has a plurality of channels characterized by a distribution of substantially non-circular channels, having sections that are substantially not equal, averagely circular, and statistically equivalent between them. Preferably, in the case of a plurality of channels with non-regular polygonal section, the channels 103 on average have bases having four or five or six or seven or eight sides. Even more preferably, an average of the number of sides of the base of each channel 103 is comprised between 4 and 8, and preferably is about 6.

Also in the case of the embodiments of FIGS. 5a-5b and 6a-6b, the channels 103 are arranged side by side and parallel to each other, so as to define a plurality of interspaces between adjacent channels. In addition, the interspaces are filled with an optically absorbing material 108 which substantially reduces or prevents the passage of light both between adjacent channels and parallel to the channels and externally thereto.

Advantageously, the optical filter comprises a plurality of channels with a non-regular polygonal section, characterized by a distribution of channels having sections that are not substantially equal, averagely circular, and statistically equivalent between them, allows the maximum coverage section or tessellation of the plane, and thus maximum transmission efficiency, while at the same time allowing for the production of an angular profile of average luminance substantially independent of the azimuth coordinate, since the orientation of the polygons is substantially random.

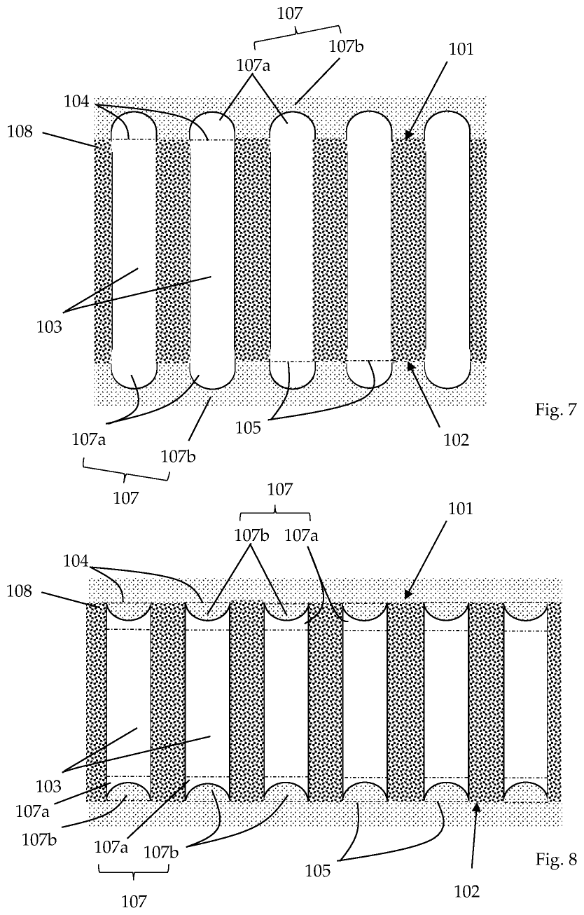

FIG. 7 shows a section of a different exemplary and non-limiting embodiment of the optical filter 100 according to the present invention that differs from the optical filter of FIG. 1a-3 in that each converging lens 107 of the first and second plurality of lenses 107 made respectively on the entry 104 and exit 105 face of each channel 103 is made in the manner of a doublet with flat and parallel faces, wherein the doublet 107 comprises an inner refractive element 107a made of a material having a first refractive index nᵢ and arranged in direct contact with the entry 104 or exit 105 face of a respective channel 103 and an outer refractive element 107b facing outwards the channel 103 and made of a material having a second refractive index nₑ. In a preferred embodiment, the inner refractive element 107a is made of a material having the first refractive index nᵢ substantially equal to the refractive index n of the at least one material by which the respective channel 103 is constituted. In other embodiments not illustrated, the inner refractive element 107a is made of a material having the first refractive index nᵢ different from the refractive index n of the at least one material by which the respective channel 103 is constituted. In a preferred embodiment of the present invention, the material by which the inner refractive element is constituted and the at least one solid material by which the channel is constituted are the same material. The inner refractive element 107a and the outer refractive element 107b are separated from each other by a convex interface surface having convexity facing outwards the channel 103, and wherein the second refractive index nₑ is less than the first refractive index nᵢ, for example nₑ/nᵢ<0.98, preferably nₑ/nᵢ<0.97, more preferably nₑ/nᵢ<0.96.

In a particular configuration, the value of the refractive index of the inner refractive 107a, nᵢ, the value of the refractive index of the outer refractive element 107b, nₑ, the value of the radius of curvature or ROC of the convex interface surface and the value of the refractive index n of the at least one material by which the respective channel 103 is constituted are such that the convergent lens 107 thus formed has focal length f in the channel satisfying the relation 0.5 L<f<2L, preferably 0.7 L<f<1.6L, more preferably 0.7 L<f<1.4L, even more preferably 0.9 L<f<1.2L, or of further preference, substantially equal to the channel length L.

Advantageously, the present embodiment makes it possible to facilitate the process of realizing the first and second plurality of converging lenses 107 by realizing them by a two-step process, which comprise:
(i) a first step for the formation of inner refractive elements 107a in contact with the channels 103 in a material having a refractive index nᵢ and having a convexity facing outwards the channel 103, with a radius of curvature; for this purpose it is sufficient to realize the inner refractive elements 107a with a radius of curvature much smaller than a radius of curvature that this surface should have to guarantee a focal length f in the middle equal to the length of the channel L, if the inner refractive elements 107a operate in direct contact with the air, for example, the convex interface surface can have a radius of curvature substantially approximable to the effective radius Rc of the channel;
(ii) a second step comprising the embedding of the inner refractive elements 107a in a matrix of polymeric material having a refractive index nₑ less than the refractive index nᵢ; the elements thus made are immersed in a layer of polymer having a refractive index nₑ configured such that, given the value nₙ of the refractive index of the inner refractive element 107a, the convex interface surface gives the doublet thus obtained a focal length f in the channel substantially equal to or close to the length of the channel L.

From the production point of view, the process for producing convex interface surfaces, for example by formation of monomer droplets through the technique of ink-jet printing or thermal melting of the head of a channel 103, is greatly simplified by decreasing the value of the radius of curvature with respect to the value necessary to guarantee a focal length f in the channel equal to the length of the channel L with air interface. For values of the radius of curvature close to the value of the effective radius Rc of the channel, the formation of droplets is in fact considerably simplified.

Considering for example the case of a channel with a circular cross-section, length L=0.8 mm, diameter 0.1 mm, and refractive index n=1.492 (PMMA), a lens that was to operate with an outer air interface, to have a focal length equal to L should have a ROC equal to about ⅓ the length of the channel L, i.e. ROC≅0.2666 mm. Conversely, considering the case of the same channel, but of a lens configured as a doublet, where the outer refractive element has a refractive index nₑ=1.414 (SILICONE) and the inner refractive element has a refractive index nᵢ=n=1.492 (PMMA), whereby nₑ/nᵢ≅0.945, it is obtained for the convex interface surface a value ROC≅0.063 mm, slightly greater than the effective radius Rc of the channel, equal to 0.05 mm.

Advantageously, the outer surface of the outer refractive elements 107b juxtaposed with each other constitutes a flat surface, ensuring maximum ease of coupling of the optical filter object of the present invention to other optical elements.

FIG. 8 shows a section of a further exemplary and non-limiting embodiment of the optical filter 100 according to the present invention. Also in this case each converging lens 107 of the first and second plurality of lenses 107 made respectively on the entry face 104 and exit face 105 of each channel 103 is made as a doublet with flat and parallel faces. The doublet 107 comprises an inner refractive element 107a made of a material having a first refractive index nᵢ and arranged in direct contact with the entry 104 or exit 105 face of a respective channel 103 and an outer refractive element 107b facing outwards the channel 103 and made of a material having a second refractive index nₑ. In a preferred embodiment, the inner refractive element 107a is made of a material having the first refractive index nᵢ substantially equal to the refractive index n of the at least one material by which the respective channel 103 is constituted. In other embodiments not illustrated in the figure the inner refractive element 107a is made of a material having the first refractive index nᵢ different from the refractive index n of the at least one material by which the respective channel 103 is constituted. In a preferred embodiment of the present invention, the material by which the inner refractive element 107a is constituted and the at least one solid material by which the channel 103 is constituted are the same material.

In the alternative embodiment illustrated in FIG. 8 the inner refractive element 107a and the outer refractive element 107b are separated from each other by a convex interface surface having convexity facing the channel 103, and wherein the second refractive index nₑ is greater than the first refractive index nᵢ, for example nₑ/nᵢ>1.02, preferably nₑ/nᵢ>1.03, preferably nₑ/nᵢ>1.04.

Also in this case, in a particular configuration, the value of the refractive index of the inner refractive 107a, nᵢ, the value of the refractive index of the outer refractive element 107b, nₑ, the value of the radius of curvature of the convex interface surface and the value of the refractive index n of the at least one material by which the respective channel 103 is constituted are such that the convergent lens 107 thus formed has focal length f in the channel satisfying the relation 0.5 L<f<2L, preferably 0.7 L<f<1.6L, more preferably 0.7 L<f<1.4L, even more preferably 0.9 L<f<1.2L, or of further preference, substantially equal to the channel length L.

In the case, for example, of a channel with a circular cross-section, length L=0.8 mm, diameter 0.1 mm, and refractive index n=1.414 (SILICONE), a lens configured as a doublet—where the outer refractive element has refractive index nₑ=1.492 (PMMA) and where the inner refractive element has a refractive index nᵢ=n=1.414 (SILICONE), whereby nₑ/nᵢ=1.055—in order to ensure a focal length in the channel f≅L will have a convex interface surface with ROC≅0.068 mm.

Also in this case, advantageously, the process of making the first and second plurality of lenses 107 is facilitated by being able to be implemented for example through a treatment of chemical etching, plasma erosion, or mechanical abrasion.

In a particular embodiment, the optically absorbing material element 108 coating the channel is configured to be less attackable or more attackable by chemical and/or mechanical erosion and/or a plasma treatment than the at least one solid material by which each channel is constituted, and/or is configured to be more easily or less easily coverable by a protective film or coating that resists chemical and/or mechanical erosion and/or a plasma treatment than the at least one solid material by which the channel is constituted.

In a further particular embodiment not depicted in the figure, each channel of the plurality of channels is configured such that the at least one solid material constituting the channel is more resistant to chemical and/or mechanical erosion and/or a plasma treatment in the outer region than the central region of the channel, and/or comprises a doping element that facilitates erosion having maximum concentration in the centre of the channel and/or wherein each channel of the plurality of channels comprises a plurality of transparent solid materials in a multilayer structure where each material of the plurality of transparent solid materials is otherwise attackable by the erosion process.

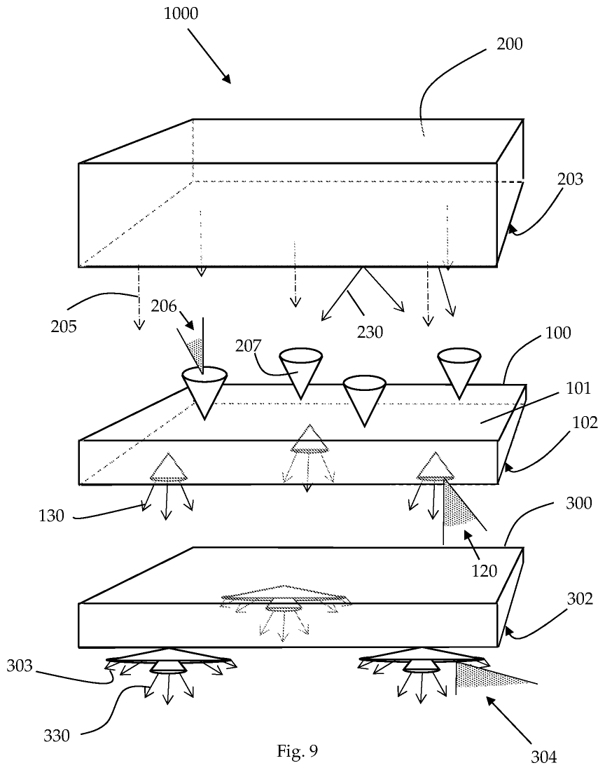

With reference to FIG. 9 a first example of a light illumination device 1000 to reproduce the light of the sun using an optical filter 100 according to the present invention is illustrated. The light illumination device 1000 comprises a direct light source 200 configured to emit visible light in a non-isotropic manner, preferably along directions in a neighbourhood of a main direction 205, having a first correlated colour temperature or first CCT. In some embodiments according to the invention, the direct light source 200 is configured to emit visible light with a fixed CCT, for example a CCT higher than 5000 degrees Kelvin. In other embodiments according to the invention, the direct light source 200 is configured to emit visible light with a variable CCT, for example a variable CCT in the range 1700-8000 degrees Kelvin.

The direct light source 200 comprises a visible light emitter, an optical system for collimating the light emitted by the visible light emitter, and a flat surface of emission 203 of the direct light. The direct light source 200 is further configured to generate light 230 primarily along directions comprised within an emission cone 207 having an emission cone directrix 205, i.e., the main emission direction 205, perpendicular to the flat emission surface 203 of the direct light. The direct light source 200 is further configured to generate a light 230 with an angular semi-opening of direct light 206, defined as the half-width of the angular luminance profile of the direct light source on the flat emission surface 203, less than 20 degrees, preferably less than 15 degrees, more preferably less than 8 degrees. In a preferred embodiment, the angular half-opening of direct light 206 is greater than 1.5, preferably 2.5, more preferably 3 degrees. In particular, the half-width is measured at a height equal to 1/e² times the peak value and the angular luminance profile is averaged on the spatial coordinates and on the azimuthal coordinate. The direct light source 200 is advantageously configured to produce on the flat emission surface 203 a substantially spatially uniform cone illuminance, wherein the cone illuminance is the illuminance relative only to the contribution of light impinging from directions comprised within the emission cone 207.

An optical filter 100 according to the invention is placed downstream of the direct light source 200 with respect to the main direction 205. Preferably, the optical filter 100 is oriented with respect to the direct light source 200 so as to have the longitudinal axis Y substantially parallel to the main direction 205. In the embodiment of FIG. 9 the optical filter 100 is positioned so as to have the first surface 101 and/or the second surface 102 oriented perpendicular to the main direction 205. In other embodiments of the invention not illustrated, the optical filter 100 is positioned so as to have the normal to the first surface 101 and/or to the second surface 102 inclined with respect to the main direction 205 by an inclination angle α (not illustrated) comprised between 5° and 80°, preferably between 10° and 70°, more preferably between 20° and 60°. In particular, the optical filter 100 is arranged with respect to the source of direct light 200 such that the entry surface 101 of the optical filter is at least partially superimposed on the flat emission surface 203 of the direct light of the direct light source 200.

In the embodiment of FIG. 9, the lighting unit of artificial light 1000 further comprises a diffused light source 300 positioned downstream of the optical filter 100 with respect to the main direction 205 so as to intercept at least partially a filtered light 130 emitted from the exit surface of the optical filter 100. The diffused light source 300 is configured to transmit, at least in part, the filtered light 130 exiting from the filter 100, specifically, at least in part, the filtered light 130 emitted from the exit surface 102 of the optical filter 100. Specifically, the diffused light source 300 is configured to produce a diffused light component 303 and a transmitted light component 330, in particular a transmitted light component 330 with an angular luminance profile similar to the angular luminance profile of the filtered light 130, i.e. characterized by the presence of a cut-off angle of value close to θ₀. In particular, the diffused light source 300 is configured to produce a light having a direct component 330 having a correlated colour temperature or CCT lower than at least 20% of the correlated colour temperature or CCT of the light produced by the direct light source 200. For example, the diffused light source 300 is a Rayleigh diffuser. In other embodiments of the invention, the diffused light source 300 is configured to transmit and/or be at least partially transparent to a light having a direct component having a CCT substantially identical to the CCT of the light produced by the direct light source 200. For example, the diffused light source 300 is a side-lit diffuser panel, i.e. lit laterally by a source other than the direct light source.

In some embodiments of the invention, the diffused light source 300 is further configured to produce a diffused light component 303 characterized by an angular luminance profile characterized by an angular diffused light divergence or half-opening defined as half-width of the angular luminance profile at height 1/e², at least 2 times, preferably 3 times, more preferably 4 times greater than the divergence or half-opening of a filter acceptance cone 120 and/or the angular filtered light half-opening 130, defined as half-width of the angular luminance profile at height 1/e² of the filtered light 130. Alternatively or additionally, the scattered light component 303 produced by the scattered light source 300 is characterized by a correlated colour temperature or CCT of at least 1.2 times, preferably 1.3 times, more preferably 1.5 times, even more preferably 1.8 times higher than the first CCT, and/or a CCT of 5600 Kelvin.

1. Optical filter (100) comprising
a substantially flat entry surface (101),
a substantially flat exit surface (102) and parallel to the entry surface,
a plurality of filled channels (103) made of a solid material substantially transparent to light, wherein the channels (103) of the plurality of channels
comprise an entry face (104), an exit face (105) and a lateral surface extending perimetrically between the entry face (104) and the exit face (105) over a length (L) of the channels (103) measured along an axis of channel (Y),
are arranged side by side and parallel to each other, with the axis of channel (Y) parallel to or inclined with respect to the normal of the entry (101) and exit (102) surface, and
are arranged with the entry face (104) substantially overlapping the entry surface (101) and with the exit face (105) substantially overlapping the exit surface (102),
at least one optically absorbing material element (108) configured and arranged around the channels (103) so as to reduce and/or substantially prevent the passage of light between adjacent channels (103) of the plurality of channels; and
a plurality of first and second converging lenses (107), wherein each channel (103) has a first converging lens of the plurality of first and second converging lenses (107) coupled to or defining its entry face (104) and a second converging lens of the plurality of first and second converging lenses (107) coupled to or defining its exit face (105), wherein the first and second lenses (107) of each channel (103) have a focal length (f) in the channel satisfying the relation 0.5 L<f<2L, preferably 0.7 L<f<1.6L, more preferably 0.7 L<f<1.4L, even more preferably 0.9 L<f<1.2L.

2. Filter (100) according to claim 1, wherein the first and second lenses (107) of each channel (103) have a focal length (f) in the channel substantially equal to the length of the channel (L).

3. Filter (100) according to claim 1 or 2, wherein each lens of the plurality of first and second converging lenses (107) is made in the form of a doublet with flat, parallel faces, wherein each doublet (107) comprises an inner refractive element (107a) made of a material having a first refractive index (nᵢ) and arranged in direct contact with the entry (104) or exit (105) face of a respective channel (103) and an outer refractive element (107b) facing outwards the channel (103) and made of a material having a second refractive index (nₑ).

4. Filter (100) according to claim 3, wherein the inner refractive element (107a) and the outer refractive element (107b) are separated from each other by a convex interface surface having convexity facing outwards the channel (103), and
wherein the second refractive index (nₑ) is less than the first refractive index (nᵢ), with the ratio of the second to the first refractive index (nₑ/nᵢ) being less than 0.98, preferably less than 0.97, more preferably less than 0.96.

5. Filter (100) according to claim 3, wherein the inner refractive element (107a) and the outer refractive element (107b) are separated from each other by a convex interface surface having convexity facing inwards the channel (103), and
wherein the second refractive index (nₑ) is greater than the first refractive index (nᵢ), with the ratio of the second to the first refractive index (nₑ/nᵢ) being greater than 1.02, preferably greater than 1.03, more preferably greater than 1.04.

6. Filter (100) according to any one of claims 3 to 5, wherein the first refractive index (nᵢ) of the material of which the inner refractive element (107a) is made is substantially equal to the refractive index (n) of the at least one material by which the respective channel (103) is constituted.

7. Filter (100) according to any one of claims 3 to 6, wherein the material by which the inner refractive element (107a) is constituted and the at least one solid material by which the respective channel (103) is constituted are the same material.

8. Filter (100) according to any one of the preceding claims, wherein each channel (103) has a section chosen from the group consisting of:
a regular polygonal section;
a substantially elliptical section;
a non-polygonal concave or convex section;
an irregular polygonal section, preferably a convex irregular polygonal section; and
a substantially circular section.

9. Optical filter (100) according to any one of the preceding claims, wherein the channels (103) of the plurality of channels (103) have a substantially identical, preferably cylindrical, conformation to each other.

10. Optical filter (100) according to any one of the preceding claims, wherein the channels of the plurality of channels have an axis of channel (Y) perpendicular to the entry (101) and exit (102) surface.

11. Optical filter (100) according to any one of the preceding claims, wherein the optically absorbing material element (108) comprises a sheath or film or varnish or a layer of rigid material substantially covering the lateral surface of the channels (103), wherein the optically absorbing material of which the optically absorbing material element (108) is made has a refractive index less than, or equal to, or greater than the refractive index of the channels (103).

12. Optical filter (100) according to any one of the preceding claims, wherein the absorption coefficient of the optically absorbing material element of which the optically absorbing material element (108) is made ensures an absorption of at least 10%, preferably 25%, more preferably 40% of the visible light for a material thickness equal to ⅕, preferably 1/10 of a diameter of the entry face or the exit face of the channels (103).

13. Optical filter (100) according to any one of the preceding claims, wherein the optical filter is configured to ensure an absorption of at least 70%, preferably 80%, more preferably 90%, even more preferably 95% of the visible light entering each channel (103) at an angle close to the opening angle of an angular acceptance cone with respect to the direction of the axis of the channel (Y).

14. Optical filter (100) according to any one of the preceding claims, wherein the first optically absorbing material element (108) comprises a jacket (108) substantially covering the lateral surface of the channels (103) and comprises a layer of rigid material, preferably selected from the group comprising glass, quartz, PMMA, polycarbonate, or other polymer resin.

15. Optical filter (100) according to any one of the preceding claims, wherein the optically absorbing material element (108) is made of a material different from the at least one material of which the channels (103) are made.

16. Optical filter (100) according to claim 15, wherein the optically absorbing material element (108) is configured to be less attackable or more attackable by chemical and/or mechanical erosion and/or erosion of a plasma treatment than the at least one solid material by which each channel (103) of the plurality of channels (103) is constituted, and/or is configured to be more easily or less easily coverable by a protective film or coating that resists chemical and/or mechanical erosion and/or erosion by a plasma treatment than the at least one solid material by which the channel is constituted.

17. Optical filter (100) according to claim 15, wherein each channel (103) of the plurality of channels (103) is configured in such a way that the at least one solid material constituting the channel (103) is more resistant to chemical and/or mechanical erosion and/or erosion of a plasma treatment in the outer region than the central region of the channel (103), and/or in such a way that the at least one solid material constituting the channel (103) comprises a doping element that facilitates erosion having maximum concentration in the centre of the channel and/or comprises a plurality of transparent solid materials organized within the channel (103) of the plurality of channels (103) into a multilayer structure where each material of the plurality of transparent solid materials is otherwise attackable by the erosion process.

18. Filter (100) according to any one of the preceding claims, wherein said filter (100) comprises a plurality of channels (103) characterized by:
a distribution of channels which are statistically equivalent to each other; and/or
a distribution of channels with an averagely circular section; and/or
a distribution of channels having a section substantially not equal between them; and/or
a distribution of channels having a substantially non-circular section.

19. Optical filter (100) according to any one of the preceding claims, wherein the material substantially transparent to the light of which the channels (103) are made is selected from the group comprising glass, quartz, PMMA, polycarbonate, or other polymer resin.

20. Optical filter (100) comprising
a substantially flat entry surface (101),
a substantially flat exit surface (102) and parallel to the entry surface,
a plurality of filled channels (103) made of a solid material substantially transparent to light, wherein the channels (103) of the plurality of channels
comprise an entry face (104), an exit face (105) and a lateral surface extending perimetrically between the entry face (104) and the exit face (105) over a length (L) of the channels (103) measured along an axis of channel (Y),
are arranged side by side and parallel to each other, with the axis of channel (Y) parallel to or inclined with respect to the normal of the entry (101) and exit (102) surface, and
are arranged with the entry face (104) substantially overlapping the entry surface (101) and with the exit face (105) substantially overlapping the exit surface (102),
at least one optically absorbing material element (108) configured and arranged around the channels (103) so as to reduce and/or substantially prevent the passage of light between adjacent channels (103) of the plurality of channels; and
a plurality of first and second converging lenses (107), wherein each channel (103) has a first converging lens of the plurality of first and second converging lenses (107) coupled to or defining its entry face (104) and a second converging lens of the plurality of first and second converging lenses (107) coupled to or defining its exit face (105),
wherein the assembly constituted by the plurality of channels (103), the at least one optically absorbing material element (108) and the plurality of first and second converging lenses (107) is configured in such a way that, given an object plane placed at a distance (D) from the entry surface (101), it generates an image plane placed at the same distance (D) from the exit surface (102), the distance (D) being measured along the direction of the axis of channel (Y) and being comprised between 0.5 D₁ and 2 D₁, preferably being comprised between 0.7 D₁ and 1.5 D₁, more preferably being comprised between 0.8 D₁ and 1.3 D₁, with D₁ being a nominal distance given by the relation:
$${D}_{1} ≃ \frac{L}{n}$$
where n is the refractive index of the at least one solid material with which the channels (103) are made.

21. Filter (100) according to claim 20, wherein each lens of the plurality of first and second converging lenses (107) is a doublet with flat, parallel faces, wherein each doublet (107) comprises an inner refractive element (107a) made of a material having a first refractive index (nᵢ) and arranged in direct contact with the entry (104) or exit (105) face of a respective channel (103) and an outer refractive element (107b) facing outwards the channel (103) and made of a material having a second refractive index (nₑ).

22. Filter (100) according to claim 21, wherein the inner refractive element (107a) and the outer refractive element (107b) are separated from each other by a convex interface surface having convexity facing outwards the channel (103), and
wherein the second refractive index (nₑ) is less than the first refractive index (nᵢ), with the ratio of the second to the first refractive index (nₑ/nᵢ) being less than 0.98, preferably less than 0.97, more preferably less than 0.96.

23. Filter (100) according to claim 21, wherein the inner refractive element (107a) and the outer refractive element (107b) are separated from each other by a convex interface surface having convexity facing inwards the channel (103), and
wherein the second refractive index (nₑ) is greater than the first refractive index (nᵢ), with the ratio of the second to the first refractive index (nₑ/nᵢ) being greater than 1.02, preferably greater than 1.03, more preferably greater than 1.04.

24. Filter (100) according to any one of claims 21 to 23, wherein the first refractive index (nᵢ) of the material of which the inner refractive element (107a) is made is substantially equal to the refractive index (n) of the at least one material by which the respective channel 103 is constituted.

25. Filter (100) according to any one of claims 21 to 24, wherein the material by which the inner refractive element (107a) is constituted and the at least one solid material by which the respective channel (103) is constituted are the same material.

26. Filter (100) according to any one of claims 20 to 25, wherein each channel (103) has a section chosen from the group consisting of:
a regular polygonal section;
a substantially elliptical section;
a non-polygonal concave or convex section;
an irregular polygonal section, preferably a convex irregular polygonal section; and
a substantially circular section.

27. Filter (100) according to any one of claims 20 to 26, wherein said filter (100) comprises a plurality of channels (103) characterized by:
a distribution of channels which are statistically equivalent to each other; and/or
a distribution of channels with an averagely circular section; and/or
a distribution of channels having a section substantially not equal between them; and/or
a distribution of channels having a substantially non-circular section.

28. Lighting device (1000) to reproduce the light of the sky and the sun comprising:
a direct light source (200) configured to emit visible light in a non-isotropic manner having a first correlated colour temperature or CCT, where the direct light source
comprises a visible light emitter, an optical system for collimating the light emitted by the visible light emitter and a flat surface of emission (203) of the direct light;
is configured to generate a light (230) mainly along directions comprised within an emission cone (207) having a directrix of the emission cone (205) perpendicular to the flat surface of emission (203) of the direct light and having an angular half-opening of direct light (206), defined as the half-width of the angular luminance profile of the direct light source on the flat emission surface (203), lower than 20 degrees, preferably lower than 15 degrees, more preferably lower than 8 degrees, wherein the half-width is measured at a height equal to 1/e² times the peak value and the angular luminance profile is averaged over the spatial coordinates and the azimuth coordinate,
an optical filter (100) according to any one of the preceding claims, positioned downstream of the direct light source so that the entry surface (101) of the optical filter is at least partially overlapping the flat surface of emission (203) of the direct light of the direct light source; and
a diffused light source (300) configured to emit a diffused visible light having a second correlated colour temperature or CCT equal to at least 1.2 times, preferably 1.3 times, more preferably 1.5 times greater than the first CCT, and which is
positioned downstream of the optical filter (100) so as to intercept at least partially a filtered light (130) emitted by the exit surface of the optical filter (100),
configured to transmit part of the filtered light (130) emitted by the exit surface (102) of the optical filter producing a transmitted light (330) whose angular luminance profile substantially coincides with the angular luminance profile of the filtered light (130) emitted by the exit surface (102) of the optical filter (100),
configured to generate, on a diffused light emission surface (302), a diffused light component (303) characterized by a luminance having an angular profile characterized by an angular half-opening of diffused light (304), defined as half-width of the angular luminance profile at height 1/e², at least twice, preferably 3 times, more preferably 4 times greater than a half-opening of an acceptance cone of the filter (120) and/or of an angular half-opening of filtered light (130), defined as half-width of the angular luminance profile at height 1/e² of the filtered light (130).

29. Lighting device (1000) to reproduce the light of the sky and the sun according to claim 28, wherein the direct light source (200) is configured to produce on the flat emission surface a substantially spatially uniform cone illuminance, wherein the cone illuminance is the illuminance relative only to the contribution of the light impinging from directions comprised within the emission cone.

30. Lighting device (1000) to reproduce the light of the sky and the sun according to claim 29, wherein the angular half-opening of direct light (206) is greater than 1.5, preferably 2.5, more preferably 3 degrees.
